(19) United States
(12) Patent Application Publication
(10) Pub. No.: US 2024/0312696 A1
(43) Pub. Date: Sep. 19, 2024

(54) ELECTRONIC COMPONENT

(71) Applicant: TDK Corporation, Tokyo (JP)

(72) Inventors: Nobuyuki OKUZAWA, Tokyo (JP); Yuichi TAKUBO, Tokyo (JP); Ryuji HASHIMOTO, Tokyo (JP); Yuta TAKAHASHI, Tokyo (JP); Hiroki HOSAKA, Tokyo (JP)

(73) Assignee: TDK Corporation, Tokyo (JP)

(21) Appl. No.: 18/429,997

(22) Filed: Feb. 1, 2024

(30) Foreign Application Priority Data
Mar. 17, 2023 (JP) 2023-042989

(51) Int. Cl. H01F 27/29; H01F 27/28

(52) U.S. Cl. CPC H01F 27/292; H01F 27/2804; H01F 2027/2809

(57) ABSTRACT

An electronic component includes: an element body having a main surface as a mounting surface; a coil portion having a coil pattern formed by a plurality of coil conductors in the element body; and a pair of external electrodes formed on the main surface of the element body and electrically connected to the coil portion, the external electrode includes a first electrode layer exposed from the main surface of the element body and a second electrode layer embedded in the element body, the first electrode layer includes a first region overlapping the second electrode layer and a second region not overlapping the second electrode layer when viewed from a first direction perpendicular to the main surface, the second region overlaps the coil conductor when viewed from the first direction, and the second electrode layer has an extended portion protruding from an outer edge of the first electrode layer.

### CROSS REFERENCE TO RELATED APPLICATIONS

This application claims priority to Japanese Patent Application No. 2023-042989 filed on Mar. 17, 2023, the entire contents of which are incorporated by reference herein.

### TECHNICAL FIELD

The present invention relates to an electronic component.

### BACKGROUND

An electronic component including an element body and an external electrode formed on a main surface of the element body is known (For example, Japanese Unexamined Patent Publication No. 2020-061409). In Japanese Unexamined Patent Publication No. 2020-061409, the electronic component has a coil portion formed in the element body. In this electronic component, adhesion to the element body is improved by an anchor effect by providing an opening in the external electrode.

### SUMMARY

In the electronic component having the above configuration, in order to secure a fixing strength between the external electrode and the element body, a certain thickness of the external electrode is required in a process. However, securing the thickness of the external electrode brings the external electrode and a coil close to each other, which causes a problem that stray capacitance is generated.

An object of one aspect of the present invention is to provide an electronic component capable of suppressing generation of the stray capacitance while securing the fixing strength between the element body and the external electrode.

An electronic component according to one aspect of the present invention includes: an element body having a main surface as a mounting surface; a coil portion having a coil pattern formed by a plurality of coil conductors in the element body; and a pair of external electrodes formed on the main surface of the element body and electrically connected to the coil portion, the external electrode includes a first electrode layer exposed from the main surface of the element body and a second electrode layer embedded in the element body, the first electrode layer includes a first region overlapping the second electrode layer and a second region not overlapping the second electrode layer when viewed from a first direction perpendicular to the main surface, the second region overlaps the coil conductor when viewed from the first direction, and the second electrode layer has an extended portion protruding from an outer edge of the first electrode layer.

The electronic component includes the first electrode layer exposed from the main surface of the element body and the second electrode layer embedded in the element body. Thus, while the first electrode layer exposed from the main surface is used for bonding to a terminal of another electronic device, the thickness of the external electrode is secured in the second electrode layer embedded in the element body, and fixability with the element body can be improved. Further, the second electrode layer has the extended portion protruding from the outer edge of the first electrode layer. Therefore, since the extended portion bites into the element body, the fixability to the element body can be improved by the anchor effect. Here, the first electrode layer includes the first region overlapping the second electrode layer and the second region not overlapping the second electrode layer when viewed from the first direction perpendicular to the main surface. Further, the second region overlaps the coil conductor when viewed from the first direction. In this case, the coil conductor at a portion corresponding to the second region faces the first electrode layer disposed at a location farther than the second electrode layer. Therefore, the generation of the stray capacitance at the portion can be suppressed. Thus, the stray capacitance generated between the entire coil conductor and the external electrode can be suppressed by an amount of the second region. As described above, it is possible to suppress the generation of the stray capacitance while securing the fixing strength between the element body and the external electrode.

The element body may include a pair of end surfaces facing each other in a second direction perpendicular to the first direction and a pair of side surfaces facing each other in a third direction perpendicular to the first direction and the second direction, and the element body may be disposed between the pair of end surfaces and the external electrodes and between the pair of side surfaces and the external electrodes when viewed from the first direction. In this case, the fixing strength to the element body can be improved as compared with a structure in which an edge portion of the external electrode is exposed from the element body.

The pair of external electrodes may have a region without the second electrode layer on an inner side in a facing direction of the pair of external electrodes. In this case, since a separation distance between the pair of external electrodes can be secured, short circuit and the like due to solder during mounting of the electronic component can be suppressed.

The extended portion of the second electrode layer may be exposed from the element body. In this case, a surface area of a bonding surface with the solder can be increased when the electronic component is mounted.

The coil conductor may be drawn out from the first electrode layer, for example, when a sufficient connection area with the second electrode layer cannot be secured.

According to the present invention, it is possible to provide an electronic component manufacturing method and an electronic component capable of suppressing the generation of the stray capacitance while securing the fixing strength between the element body and the external electrode.

### BRIEF DESCRIPTION OF THE DRAWINGS

FIG. 1 is a perspective view illustrating an electronic component according to the present embodiment;

FIG. 2A is a cross-sectional view taken along line IIa-IIa in FIG. 1, FIG. 2B is a cross-sectional view taken along line IIb-IIb in FIG. 1, and FIG. 2C is a cross-sectional view taken along line IIc-IIc in FIG. 1;

FIG. 3A is a plan view of the electronic component, and FIG. 3B is an enlarged view of FIG. 2C;

FIG. 4 is a view for explaining stray capacitance;

FIGS. 5A to 5F are schematic views illustrating a method for manufacturing the electronic component;

FIG. 6 is a view illustrating a comparative example;

FIGS. 7A to 7D are views illustrating a modification; and

FIGS. 8A to 8D are views illustrating a modification.

### DETAILED DESCRIPTION

Hereinafter, an embodiment of the present invention will be described in detail with reference to the drawings. In description of the drawings, the same or equivalent elements are denoted by the same reference numerals, and redundant description will be omitted.

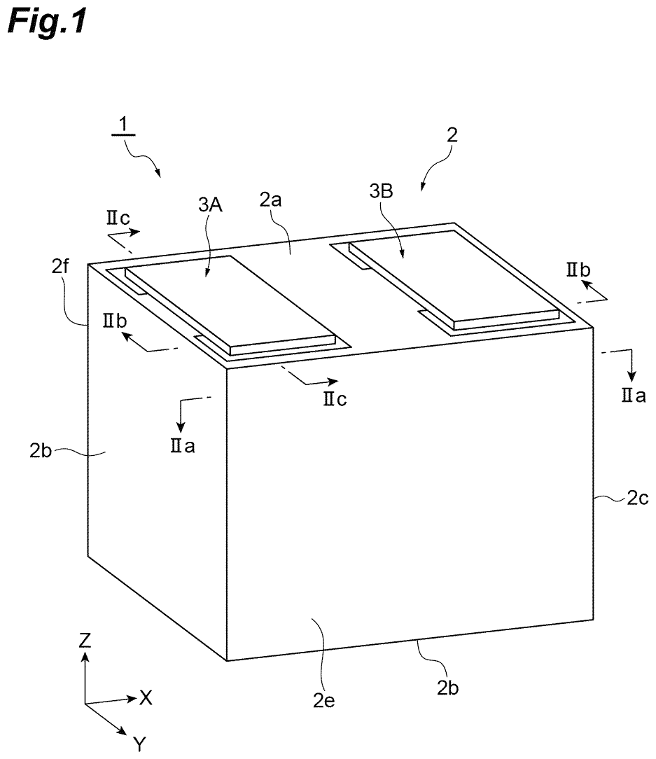

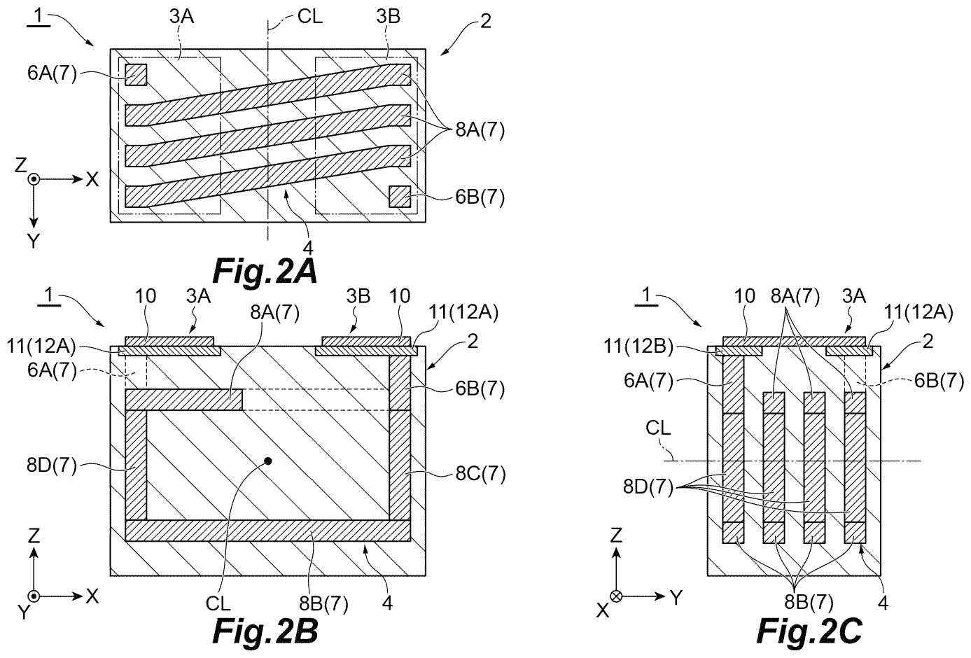

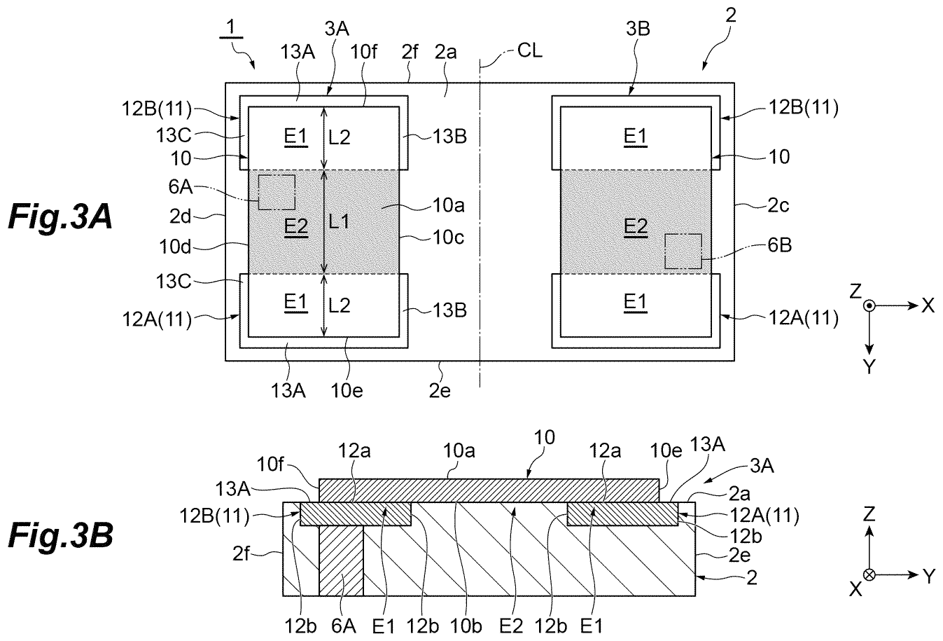

First, a schematic configuration of an electronic component 1 according to the present embodiment will be described with reference to FIGS. 1 to 3A and 3B. FIG. 1 is a perspective view illustrating the electronic component 1 according to the present embodiment. FIG. 2A is a cross-sectional view taken along line IIa-IIa in FIG. 1. FIG. 2B is a cross-sectional view taken along line IIb-IIb in FIG. 1. FIG. 2C is a cross-sectional view taken along line IIc-IIc in FIG. 1. FIG. 3A is a plan view of the electronic component 1, and FIG. 3B is an enlarged view of FIG. 2C. The electronic component in the present embodiment is formed by laminating a plurality of layers in a Z-axis direction. The layers are integrated to such an extent that boundaries between the layers cannot be visually recognized. In the present embodiment, an X-axis direction, a Y-axis direction, and the Z-axis direction are perpendicular to each other. The Z-axis direction corresponds to a “first direction” in the claims, the X-axis direction perpendicular to the Z-axis direction corresponds to a “second direction” in the claims, and the Y-axis direction perpendicular to the Z-axis direction and the X-axis direction corresponds to a “third direction” in the claims.

As illustrated in FIG. 1, the electronic component 1 includes an element body 2 and external electrodes 3A and 3B.

The element body 2 has a rectangular parallelepiped shape. The element body 2 has, as outer surfaces thereof, main surfaces 2a and 2b facing each other in the Z-axis direction, a pair of end surfaces 2c and 2d facing each other in the X-axis direction, and a pair of side surfaces 2e and 2f facing each other in the Y-axis direction. The main surface 2a is disposed on a positive side in the Z-axis direction, and the main surface 2b is disposed on a negative side in the Z-axis direction. The end surface 2c is disposed on a positive side in the X-axis direction, and the end surface 2d is disposed on a negative side in the X-axis direction. The side surface 2e is disposed on a positive side in the Y-axis direction, and the side surface 2f is disposed on a negative side in the Y-axis direction. For example, when the electronic component 1 is mounted on another electronic device (for example, a circuit board or an electronic component) not illustrated, the main surface 2a is defined as a mounting surface facing the other electronic device.

The external electrodes 3A and 3B are formed on the main surface 2a of the element body 2. Further, the external electrodes 3A and 3B are electrically connected to a coil portion described later in the element body 2. When the electronic component 1 is mounted on the electronic device, the external electrodes 3A and 3B are bonded to terminals of the electronic device by soldering or the like.

As illustrated in FIGS. 2A to 2C, the electronic component 1 includes a coil portion 4 and lead-out portions 6A and 6B inside the element body 2. The coil portion 4 is a portion in which a coil pattern is formed by a plurality of coil conductors 7 in the element body 2. Note that the lead-out portions 6A and 6B are also parts of the coil conductor 7. In the present embodiment, the coil portion 4 is a coil wound around an axis as a center line CL parallel to the Y-axis direction.

The coil portion 4 is wound to form a rectangular annular pattern when viewed from the Y-axis direction. The coil portion 4 includes, as the coil conductor 7, a first side portion 8A disposed on the positive side in the Z-axis direction from the center line CL and extending in the X-axis direction, a second side portion 8B disposed on the negative side in the Z-axis direction from the center line CL and extending in the X-axis direction, a third side portion 8C disposed on the positive side in the X-axis direction from the center line CL and extending in the Z-axis direction, and a fourth side portion 8D disposed on the negative side in the X-axis direction from the center line CL and extending in the Z-axis direction.

The lead-out portion 6A extends in the Z-axis direction from one end of the coil portion 4 and is connected to the external electrode 3A. The lead-out portion 6B extends in the Z-axis direction from the other end of the coil portion 4 and is connected to the external electrode 3B. The lead-out portion 6A is connected to an end portion on the positive side in the Z-axis direction at the fourth side portion 8D disposed on the most negative side in the Y-axis direction. The lead-out portion 6B is connected to an end portion on the positive side in the Z-axis direction at the third side portion 8C disposed on the most positive side in the Y-axis direction.

Next, a detailed configuration of the external electrodes 3A and 3B will be described with reference to FIGS. 3A and 3B. Note that the external electrode 3A and the external electrode 3B are line-symmetric with respect to the center line CL when viewed from the Z-axis direction. Therefore, hereinafter, the configuration of the external electrode 3A will be described, and description of the external electrode 3B will be omitted. The external electrode 3A includes a first electrode layer 10 and a second electrode layer 11.

The first electrode layer 10 has a rectangular shape with its longitudinal direction as the Y-axis direction. The first electrode layer 10 has main surfaces 10a and 10b, side surfaces 10c and 10d, and end surfaces 10e and 10f. The main surfaces 10a and 10b are surfaces facing each other in the Z-axis direction. The main surface 10a is disposed on the positive side in the Z-axis direction. The main surface 10b is disposed on the negative side in the Z-axis direction. The side surfaces 10c and 10d are surfaces facing each other in the X-axis direction. The side surface 10c is disposed on the positive side in the X-axis direction. The side surface 10d is disposed on the negative side in the X-axis direction. The end surfaces 10e and 10f are surfaces facing each other in the Y-axis direction. The end surface 10e is disposed on the positive side in the Y-axis direction. The end surface 10f is disposed on the negative side in the Y-axis direction.

The side surface 10c of the first electrode layer 10 is disposed at a position away from the center line toward the negative side in the X-axis direction. The side surface 10d is disposed at a position away from the end surface 2d of the element body 2 toward the positive side in the X-axis direction. The end surface 10e is disposed at a position away from the side surface 2e of the element body 2 toward the negative side in the Y-axis direction. The end surface 10f is disposed at a position away from the side surface 2f of the element body 2 toward the positive side in the Y-axis direction.

The first electrode layer 10 is an electrode layer exposed from the main surface 2a of the element body 2. In the first electrode layer 10, at least the main surface 10a on the positive side in the Z-axis direction is exposed from the main surface 2a of the element body 2. Further, in the present embodiment, the side surfaces 10c and 10d and the end surfaces 10e and 10f are also exposed from the main surface 2a (see FIG. 3B).

The second electrode layer 11 is an electrode layer disposed on the negative side in the Z-axis direction from the first electrode layer 10 and embedded in the element body 2 (see FIG. 3B). The second electrode layer 11 has a first portion 12A and a second portion 12B. The first portion 12A is a portion overlapping an edge portion of the first electrode layer 10 near the end surface 10e on the positive side in the Y-axis direction. The second portion 12B is a portion overlapping an edge portion of the first electrode layer 10 near the end surface 10f on the negative side in the Y-axis direction. Each of the portions 12A and 12B is bonded, at a main surface 12a on the positive side in the Z-axis direction thereof, to the main surface 10b of the first electrode layer 10 on the negative side in the Z-axis direction.

The first portion 12A and the second portion 12B have a rectangular shape with its longitudinal direction as the X-axis direction. The first portion 12A and the second portion 12B are separated from each other so as to form a gap in the Y-axis direction. A separation distance L1 between the two in the Y-axis direction is not particularly limited, but may be larger than a dimension L2 in the Y-axis direction of a region where each of the portions 12A and 12B overlaps the first electrode layer 10.

Each of the portions 12A and 12B of the second electrode layer 11 has extended portions 13A, 13B, and 13C protruding from an outer edge of the first electrode layer 10. The extended portion 13A protrudes from the outer edge on an outer side in the Y-axis direction of the first electrode layer 10. The extended portion 13A of the first portion 12A protrudes from the outer edge on the end surface 10e side. The extended portion 13B of the second portion 12B protrudes from the outer edge on the end surface 10f side. The extended portion 13B protrudes from the outer edge on the side surface 10c side of the first electrode layer 10. The extended portion 13C protrudes from the outer edge on the side surface 10d side of the first electrode layer 10.

Further, in the present embodiment, the extended portions 13A, 13B, and 13C of each of the portions 12A and 12B of the second electrode layer 11 are exposed from the element body 2. The main surface 12a of each of the portions 12A and 12B is exposed from the main surface 2a of the element body 2 in the extended portions 13A, 13B, and 13C. Note that four peripheral surfaces 12b of each of the portions 12A and 12B are embedded in the element body 2. Thus, the second electrode layer 11 has a configuration in which a part thereof is embedded in the element body 2 and a part thereof is exposed from the element body 2.

The extended portion 13C of the first portion 12A is disposed at a position away from the end surface 2d of the element body 2 toward the positive side in the X-axis direction. The extended portion 13A of the first portion 12A is disposed at a position away from the side surface 2e of the element body 2 toward the negative side in the Y-axis direction. The extended portion 13C of the second portion 12B is disposed at a position away from the end surface 2d of the element body 2 toward the positive side in the X-axis direction. The extended portion 13A of the second portion 12B is disposed at a position away from the side surface 2f of the element body 2 toward the positive side in the Y-axis direction. Thus, the element body 2 is disposed between the pair of end surfaces 2c and 2d and the external electrodes 3A and 3B and between the pair of side surfaces 2e and 2f and the external electrodes 3A and 3B when viewed from the Z-axis direction.

On the side surface 10c on the center line CL side of the first electrode layer 11, the extended portion 13B of each of the portions 12A and 12B protrudes, but the second electrode layer 11 does not exist in a region where the portions 12A and 12B do not exist. Therefore, a pair of external electrodes 3A and 3B has a region without the second electrode layer 11 on an inner side in a facing direction (the X-axis direction) of the pair of external electrodes 3A and 3B.

With the above configuration, as illustrated in FIG. 3A, the first electrode layer 11 has a first region E1 overlapping the second electrode layer 11 and a second region E2 not overlapping the second electrode layer 11 when viewed from the Z-axis direction. The first region E1 includes a region where the first electrode layer 11 overlaps the first portion 12A and a region where the first electrode layer 11 overlaps the second portion 12B. In the present embodiment, the second region E2 is formed between the first region E1 on the positive side in the Y-axis direction and the first region E1 on the negative side in the Y-axis direction. In FIG. 3A, the second region E2 is gray-scaled.

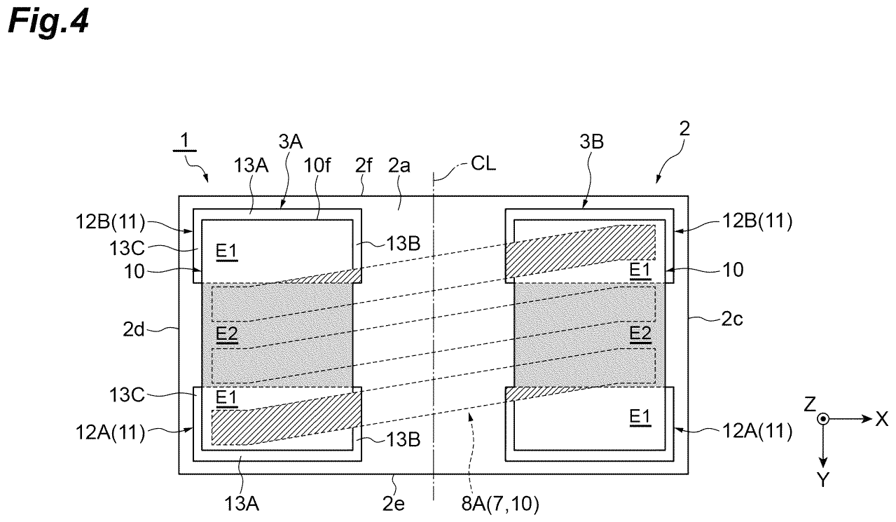

Next, overlapping between the external electrodes 3A and 3B and the coil conductor 7 when viewed from the Z-axis direction will be described with reference to FIG. 4. In FIG. 4, in the coil portion 4, a plurality of the first side portions 8A that are closest to the external electrodes 3A and 3B and can generate stray capacitance are indicated by broken lines. When viewed from the Z-axis direction, the second electrode layer 11 of the external electrodes 3A and 3B overlaps the coil conductor 7. Further, the second region E2 of the external electrodes 3A and 3B overlaps the coil conductor 7.

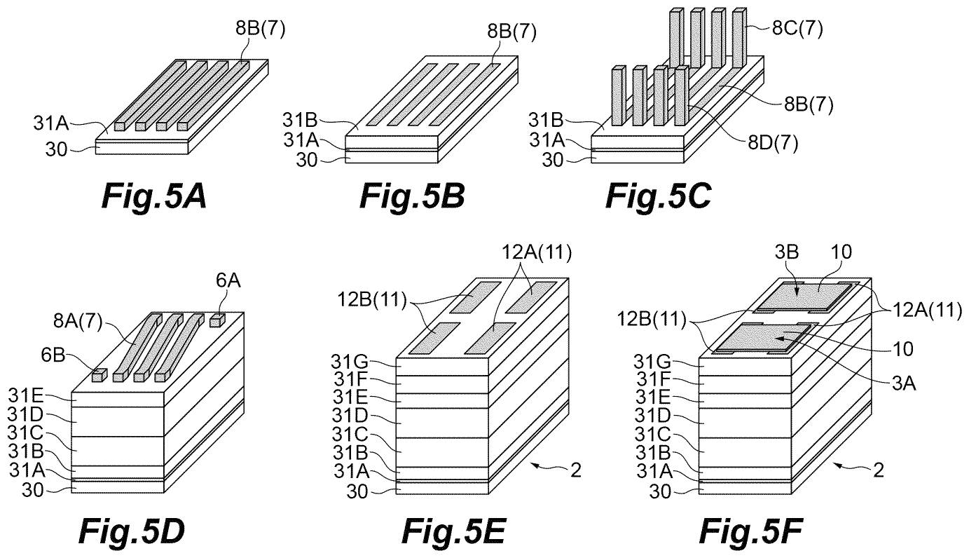

Next, a method for manufacturing the electronic component 1 will be described with reference to FIGS. 5A to 5F.

First, as illustrated in FIG. 5A, a base member 30 to be a part of the element body 2 is prepared, and an insulating layer 31A is formed by applying a material of the element body 2 to an upper surface of the base member 30. The second side portion 8B of the coil conductor 7 is formed on an upper surface of the insulating layer 31A. The second side portion 8B is formed by forming an electrode film on the upper surface of the insulating layer 31A, exposing the electrode film using a resist, plating the conductor then peeling off the resist, and etching the electrode film. Note that in the subsequent formation of the coil conductor 7, the same step is performed.

Next, as illustrated in FIG. 5B, the second side portion 8B is embedded with an insulating layer 31B, and an upper surface thereof is polished. Next, as illustrated in FIG. 5C, the side portions 8C and 8D of the coil conductor 7 are formed to rise. Note that the side portions 8C and 8D may be formed by repeating a step of forming a part of the coil conductor 7 and embedding the part with a laminate layer a plurality of times. Here, as illustrated in FIG. 5D, a step for two layers of insulating layers 31C and 31D is performed to form the side portions 8C and 8D. Thereafter, the first side portion 8A and an insulating layer 31E of the coil conductor 7 are formed. The lead-out portions 6A and 6B are formed for the first side portion 8A, and an insulating layer 31F (see FIG. 5E) that embeds the lead-out portions 6A and 6B is formed.

Next, as illustrated in FIG. 5E, the second electrode layer 11 and an insulating layer 31G that embeds the second electrode layer 11 are formed. Thus, the element body 2 is completed. Then, as illustrated in FIG. 5F, the first electrode layer 10 is formed on a main surface of the second electrode layer 11. Thus, the external electrodes 3A and 3B are completed.

Next, operations and effects of the electronic component 1 according to the present embodiment will be described.

The electronic component 1 includes the first electrode layer 10 exposed from the main surface 2a of the element body 2 and the second electrode layer 11 embedded in the element body 2. Thus, while the first electrode layer 10 exposed from the main surface 2a is used for bonding to a terminal of another electronic device, the thickness of the external electrodes 3A and 3B is secured in the second electrode layer 11 embedded in the element body 2, and fixability with the element body 2 can be improved. Further, the second electrode layer 11 has the extended portions 13A, 13B, and 13C protruding from the outer edge of the first electrode layer 10. Therefore, since the extended portions 13A, 13B, and 13C bite into the element body 2, the fixability to the element body 2 can be improved by an anchor effect.

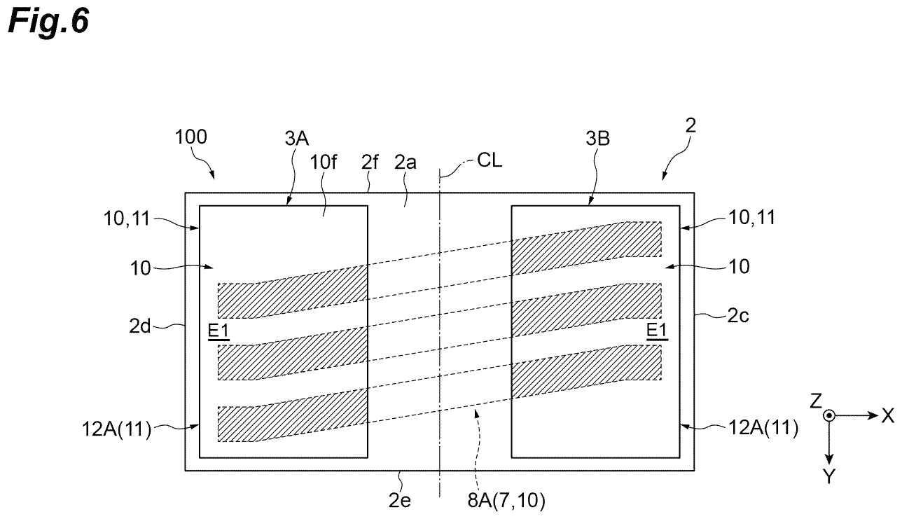

Here, the stray capacitance of an electronic component 100 according to a comparative example will be described with reference to FIG. 6. The electronic component 100 has the same configuration as the electronic component 1 according to the present embodiment except that the first electrode layer 10 and the second electrode layer 11 have the same shape and are the first region E1 overlapping the second electrode layer 11 over the entire surface of the first electrode layer 10. In the component 100 according to the comparative example, the second electrode layer 11 close to the coil conductor 7 faces the entire area of the coil conductor 7 overlapping the external electrodes 3A and 3B. In the coil conductor 7, a portion facing the second electrode layer 11 is hatched. As described above, since the area of the coil conductor 7 facing the second electrode layer 11 is large, there is a possibility that the stray capacitance increases.

In contrast, in the electronic component 1 according to the present embodiment, the first electrode layer 10 has the first region E1 overlapping the second electrode layer 11 and the second region E2 not overlapping the second electrode layer 11 when viewed from the Z-axis direction. Further, the second region E2 overlaps the coil conductor 7 when viewed from the Z-axis direction. In this case, the coil conductor 7 at a portion corresponding to the second region E2 faces the first electrode layer 10 disposed at a location farther than the second electrode layer 11. Therefore, the generation of the stray capacitance at the portion can be suppressed. Thus, the stray capacitance generated between the entire coil conductor 7 and the external electrodes 3A and 3B can be suppressed by an amount of the second region E2. Specifically, an area of a hatched portion illustrated in FIG. 4 is smaller than an area of a hatched portion illustrated in FIG. 6. The generation of the stray capacitance can be suppressed by an amount of reduction in the area. As described above, it is possible to suppress the generation of the stray capacitance while securing the fixing strength between the element body 2 and the external electrodes 3A and 3B.

The element body 2 may include the pair of end surfaces 2c and 2d facing each other in the X-axis direction and the pair of side surfaces 2e and 2f facing each other in the Y-axis direction, and the element body 2 may be disposed between the pair of end surfaces 2c and 2d and the external electrodes 3A and 3B and between the pair of side surfaces 2e and 2f and the external electrodes 3A and 3B when viewed from the Z-axis direction. In this case, the fixing strength to the element body 2 can be improved as compared with a structure in which edge portions of the external electrode 3A and 3B are exposed from the element body.

The pair of external electrodes 3A and 3B may have the region without the second electrode layer 11 on the inner side in the facing direction (the X-axis direction) of the pair of external electrodes 3A and 3B. In this case, since a separation distance between the pair of external electrodes 3A and 3B can be secured, short circuit and the like due to solder during mounting of the electronic component 1 can be suppressed.

The extended portions 13A, 13B, and 13C of the second electrode layer 11 may be exposed from the element body 2. In this case, a surface area of a bonding surface with the solder can be increased when the electronic component 1 is mounted.

The present invention is not limited to the above-described embodiment.

For example, the coil conductor 7 (lead-out portions 6A and 6B) may be drawn out from the first electrode layer 10 as indicated by virtual lines in FIG. 3A. When an area of the electrode layer 11 is small and a connection portion with the lead-out portion cannot be sufficiently secured, a connection area between the external electrodes 3A and 3B and the lead-out portions 6A and 6B can be secured by drawing out the lead-out portions 6A and 6B from the first electrode layer 10.

For example, the shape of the second electrode layer 11 can be appropriately changed without departing from the gist of the invention.

Further, in the above-described embodiment, the main surface 12a of the second electrode layer 11 is exposed from the main surface 2a of the element body 2, but may be embedded in the element body 2. In this case, the anchor effect by the second electrode layer 11 can be further improved.

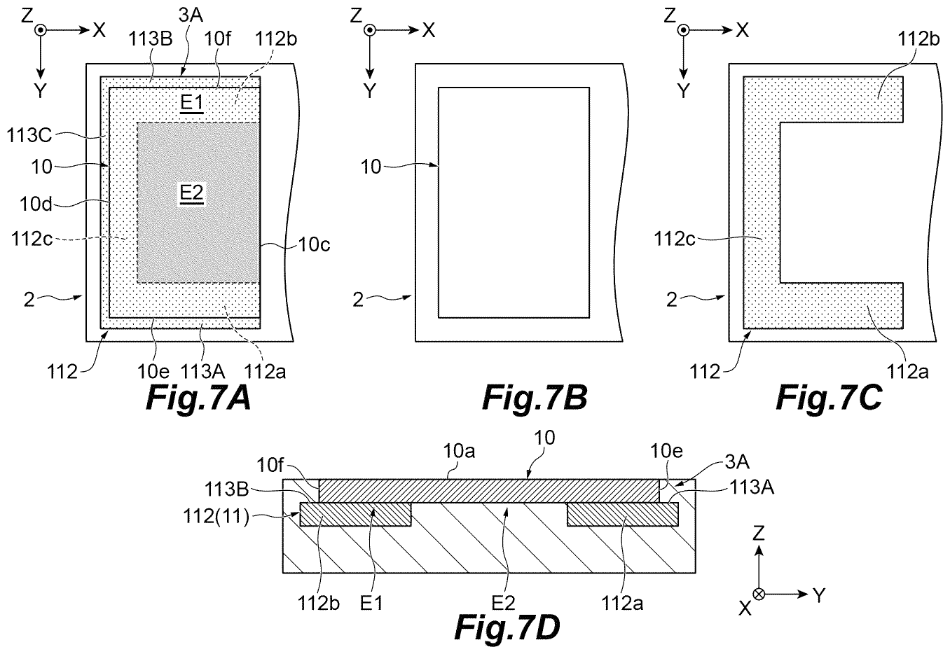

Specifically, a second electrode layer 112 as illustrated in FIGS. 7A to 7D may be adopted. FIG. 7A is a plan view of the external electrode 3A. FIG. 7B illustrates a state in which the second electrode layer 112 is omitted, and FIG. 7C illustrates a state in which the first electrode layer 10 is omitted. FIG. 7D illustrates a cross-sectional view of a portion corresponding to FIG. 3B. As illustrated in FIG. 7A, the second electrode layer 112 includes a first portion 112a extending in the X-axis direction along the end surface 10e of the first electrode layer 10, a second portion 112b extending in the X-axis direction along the end surface 10f, and a third portion 112c extending in the Y-axis direction along the side surface 10d. Further, the second electrode layer 112 has the extended portions 113A, 113B, and 113C respectively protruding from edge portions of the first electrode layer 10. Note that the second electrode layer 112 does not have a portion protruding from the side surface 10c side.

With such a structure, the first electrode layer 10 has the first region E1 near the end surfaces 10e and 10f and the side surface 10d, and the second region E2 surrounded by the portions 112a, 112b, and 112c. Note that as illustrated in FIG. 7D, the entire second electrode layer 112 is embedded in the element body 2, and the surfaces 10c, 10d, 10e, and 10f of the first electrode layer 10 are also embedded in the element body 2. Thus, the fixing strength of the external electrode 3A to the element body 2 is improved.

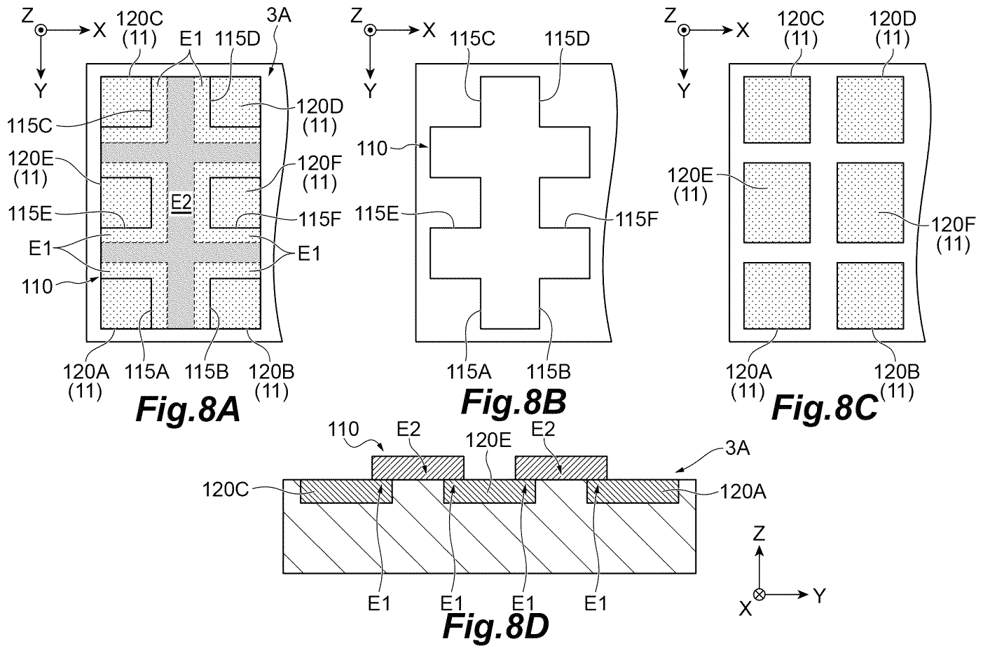

In addition, the external electrode 3A as illustrated in FIGS. 8A to 8D may be employed. FIG. 8A is a plan view of the external electrode 3A. FIG. 8B illustrates a state in which the second electrode layer 11 is omitted, and FIG. 8C illustrates a state in which the first electrode layer 110 is omitted. FIG. 8D illustrates a cross-sectional view of a portion corresponding to FIG. 3B. As illustrated in FIG. 8B, the first electrode layer 110 has a shape in which rectangular cutout portions 115A, 115B, 115C, and 115D are formed at four corners of a rectangular electrode layer 10 illustrated in FIG. 7A, and rectangular cutout portions 115E and 115F are formed at respective edge portions of a central portion in the Y-axis direction. On the other hand, the second electrode layer 11 has rectangular electrode portions 120A, 120B, 120C, 120D, 120E, and 120F at positions respectively corresponding to the cutout portions 115A, 115B, 115C, 115D, 115E, and 115F. The electrode portions 120A, 120B, 120C, 120D, 120E, and 120F overlap edge portions of the cutout portions 115A, 115B, 115C, 115D, 115E, and 115F, and portions exposed from the cutout portions serve as extended portions.

### Embodiment 1

An electronic component including:
an element body having a main surface as a mounting surface;
a coil portion having a coil pattern formed by a plurality of coil conductors in the element body; and
a pair of external electrodes formed on the main surface of the element body and electrically connected to the coil portion, in which
the external electrode includes a first electrode layer exposed from the main surface of the element body and a second electrode layer embedded in the element body,
the first electrode layer includes a first region overlapping the second electrode layer and a second region not overlapping the second electrode layer when viewed from a first direction perpendicular to the main surface,
the second region overlaps the coil conductor when viewed from the first direction, and
the second electrode layer has an extended portion protruding from an outer edge of the first electrode layer.

### Embodiment 2

The electronic component according to Embodiment 1, in which
the element body includes a pair of end surfaces facing each other in a second direction perpendicular to the first direction and a pair of side surfaces facing each other in a third direction perpendicular to the first direction and the second direction, and
the element body is disposed between the pair of end surfaces and the external electrodes and between the pair of side surfaces and the external electrodes when viewed from the first direction.

### Embodiment 3

The electronic component according to Embodiment 1 or 2, in which the pair of external electrodes has a region without the second electrode layer on an inner side in a facing direction of the pair of external electrodes.

### Embodiment 4

The electronic component according to any one of Embodiments 1 to 3, in which the extended portion of the second electrode layer is exposed from the element body.

### Embodiment 5

The electronic component according to any one of Embodiments 1 to 4, in which the coil conductor is drawn out from the first electrode layer.

### REFERENCE SIGNS LIST

1 Electronic component
2 Element body
3A, 3B External electrode
4 Coil portion
7 Coil conductor
10 Coil portion
10 First electrode layer
11 Second electrode layer
13A, 13B, 13C Extended portion
E1 First region
E2 Second region

What is claimed is:

1. An electronic component comprising:
an element body having a main surface as a mounting surface;
a coil portion having a coil pattern formed by a plurality of coil conductors in the element body; and
a pair of external electrodes formed on the main surface of the element body and electrically connected to the coil portion, wherein
the external electrode includes a first electrode layer exposed from the main surface of the element body and a second electrode layer embedded in the element body,
the first electrode layer includes a first region overlapping the second electrode layer and a second region not overlapping the second electrode layer when viewed from a first direction perpendicular to the main surface,
the second region overlaps the coil conductor when viewed from the first direction, and
the second electrode layer has an extended portion protruding from an outer edge of the first electrode layer.

2. The electronic component according to claim 1, wherein
the element body includes a pair of end surfaces facing each other in a second direction perpendicular to the first direction and a pair of side surfaces facing each other in a third direction perpendicular to the first direction and the second direction, and
the element body is disposed between the pair of end surfaces and the external electrodes and between the pair of side surfaces and the external electrodes when viewed from the first direction.

3. The electronic component according to claim 1, wherein the pair of external electrodes has a region without the second electrode layer on an inner side in a facing direction of the pair of external electrodes.

4. The electronic component according to claim 1, wherein the extended portion of the second electrode layer is exposed from the element body.

5. The electronic component according to claim 1, wherein the coil conductor is drawn out from the first electrode layer.
